(19) United States
(12) Patent Application Publication
(10) Pub. No.: US 2024/0426159 A1
(43) Pub. Date: Dec. 26, 2024

(54) METHOD FOR OPERATING AN AUTOMATIC DOOR SYSTEM AS WELL AS SYSTEM HAVING AN AUTOMATIC DOOR SYSTEM

(71) Applicant: Assa Abloy Entrance Systems AB, Landskrona (SE)

(72) Inventor: Marco HAURI, Galgenen (CH)

(21) Appl. No.: 18/692,354

(22) PCT Filed: Sep. 20, 2022
(86) PCT No.: PCT/EP2022/076132

§ 371 Date: Mar. 15, 2024

(30) Foreign Application Priority Data
Sep. 23, 2021 (SE) 2130253-4

(51) Int. Cl. E05F 15/73

(52) U.S. Cl. CPC E05F 15/73; E05F 2015/767; E05Y 2900/132

(57) ABSTRACT

A method for operating an automatic door system (14) is provided. The door system (14) comprises at least one door (16), at least one drive unit (22), a camera (24) and an analysis unit (12) having a measure module (32) and an adaption module (34). The method comprises the following steps: recognizing at least one object by the analysis unit (12) in a recording, determining a measure based on the recognized object and the expected behavior using the measure module (32), controlling the drive unit (22) according to the determined measure, recognizing the actual behavior of the object in the recording after the drive unit (22) has been actuated, determining a deviation of the actual behavior from the expected behavior. and adapting the measure module (32) based on the deviation by the adaption module (34). Further, a system (10) is provided.

The invention concerns a method for operating an automatic door system as well as a system having an automatic door system.

Automatic door systems, for example at buildings, are well known in the art. Today, automatic door systems are based on a sensor for proximity detection to detect an object close to the door. In response to an object close to the door, the door is opened irrespectively of the actual desire of the person (or the object) in front of the door to pass the door.

Thus, known door systems open the door for any person or even objects close to the door and the door is always opened in the same manner. It can be said that the door system is agnostic.

It is known to use different technologies, i.e. radar, camera, or the like, to detect persons that would like to pass through the door. However, the locations that door systems are mounted in differ from one another so that the conclusion whether or not a person would like to pass through the door may be specific for the location the door is set up at.

It is the object of the invention to provide a method for operating a door system that ensures a door movement specific to the actual situation in front of the door.

For this purpose, a method for operating an automatic door system using an analysis unit is provided. The door system comprises at least one door, at least one drive unit for actuating the at least one door, a camera and a control unit for controlling the drive unit, wherein the analysis unit comprises a measure module and an adaption module. The method comprises the following steps:
capturing at least one recording by the camera, wherein the recording includes at least the area in front of the door,
transmitting the recording to the analysis unit,
recognizing at least one object by the analysis unit,
determining a measure based on the at least one recognized object and an expected behavior of the object using the measure module,
controlling the drive unit according to the determined measure,
continuing to capture the recording after the measure has been determined,
recognizing the actual behavior of the object in the recording after the drive unit has been controlled according to the determined measure,
determining a deviation of the actual behavior of the object from the expected behavior of the object, and
adapting the measure module based on the deviation by the adaption module.

By determining a measure based on an expected behavior, it is ensured that the measure is specific for the situation and suitable for the need of the person. Further, by adapting the measure module based on the actual behavior, the system is capable of adapting to specific situations that are, for example, due to the location the system is set up at. Such a location may be at a corner of the building at an intersection with heavy pedestrian traffic.

For example, the expected behavior is the simple expectation that the object will pass the door without collision with the door leaves. This simple expectation may be used in all cases the door opens.

In more sophisticated embodiments, the expected behavior is for example the probability that an object will pass the door and/or the probability that an object will collide with the door, in particular a door leaf. These probabilities may be predicted.

The term “measure” may also refer to situations in which the door is kept closed or open, i.e. the measure may not lead to a visible action or change of the door. In this case the drive unit may be controlled to keep the door closed, for example by not sending signals to the drive unit.

The door may be a swing door, a revolving door, a sliding door, a folding door or the like. The door may comprise a door leaf, which is actuated by the drive unit.

In particular, the control of the door may be based on one or more than one object recognized in the recording simultaneously.

The camera may be an integral part of the safety functionality of the door and monitors the track of the door. In particular, the camera monitors the track of the door leaf.

The camera may be mounted above the door.

For example, the recording includes parts of the track of the door leaves and an area of up to 5 m, preferably up to 7 m, more preferably still up to 10 m (measured on the ground) in front of the door.

The analysis unit, in particular the measure module, may be part of the door system, in particular a part of the control unit, and/or the adaption module may be separate from the door system, for example provided as a cloud server, a server on premise or a mobile service device that is not always connected to the door system.

It is also conceivable that the drive unit receives steering input from the analysis unit or the control unit. In the latter case, the analysis unit transmits the recognized object and/or the type of the object to the control unit.

For example, the at least one object is a person, an animal, a movable object or a stationary object allowing the analysis unit to process the situation in its entirety.

Accordingly, the type of the object may be “person” for a person, “dog” for an animal being a dog, “trolley” for a moveable object being a trolley or “tree” for a stationary object being a tree.

A moveable object is, for example, any inanimate object that may be carried by a person, like a bag or backpack, may be rolling and pushed or pulled by a person, like a stroller, a bicycle or a trolley, and/or is self-propelled, like an e-scooter or a car.

In an aspect of the invention, the measure is determined based on at least one individual property of the at least one object in the recording, based on at least one kinematic property of the at least one object in the recording, particularly a kinematic property of a kinematic subpart of the at least one object, and/or based on at least one image processing property of the at least one object in the recording, in particular wherein the kinematic property of the at least one object is the change of position, the velocity, the change of velocity, the acceleration, the change of acceleration, the position, the distance to the door and/or the direction of movement of the object and/or of its kinematic subpart. This way, the measure can be selected very specifically.

The velocity, the change of velocity, the acceleration, the change of acceleration, the position, the distance to the door and/or the direction of movement may be determined for each spatial direction separately, in particular for each of the two spatial directions parallel to the ground. For example, a two dimensional vector is determined for each of the velocity, the change of velocity, the acceleration, the change of acceleration, the position, the distance to the door and/or the direction of movement.

In particular, a kinematic property may be the kinematic property of a subpart of the object. The subpart of an object is, for example, a part of an object that may move in addition to the general movement of the object. Examples are the skeleton function of a human or an animal, a body part of a human or animal, like an arm, a leg or the head, or parts of an object extending from the main part of the object, like the handlebar of a bicycle.

For the ease of understanding, kinematic properties of a kinematic subpart are also meant when referring to the kinematic properties of the object within this disclosure.

An individual property may be one or more of the following properties:
if the object is a person: age, size, ethnicity, clothes worn, items carried, type of locomotion, orientation, pose, viewing direction, level of attention, state of health, mood, current activity, performed gesture, behavior, gait and/or posture; and/or
if the object is an animal: species, breed, whether the animal is wet, whether the animal carries prey, whether the animal is on a leash and/or whether the animal is wearing a muzzle; and/or
if the object is a movable object: whether the object is associated with and/or carried by a person.

An image processing property of the at least one object in the recording may be the bounding box, the closure, the timeline of properties and/or fusion of the object with other objects.

In an aspect, the expected behavior is predicted by the measure module prior to and/or during the determination of the measure, in particular wherein the adaption module adapts the way the measure module predicts the expected behavior based on the deviation. By predicting the expected behavior, the measure can be chosen even more specifically.

The prediction of the expected behavior may be used during the determination of the measure.

Further, the determination of the measure and/or the prediction of the expected behavior may be carried out in short succession, even if the measure itself has not been carried out yet. In case of a video as a recording, the determination of the measure and/or the prediction may be carried out for each frame and/or for a certain period of time using a sequence of multiple frames.

The measure from previous determinations, e.g. based on previous frames and/or sequence of frames, may be changed by succeeding determinations.

In order to predict the expected behavior easily, the expected behavior may be assumed to be:
a continuation in the behavior of the object, in particular with constant and/or typical kinematic properties of the object prior to and after the control of the drive unit, in particular when the object passes the door; and/or
predetermined and stored for an object, in particular in combination with its type, its at least one individual property, its at least one kinematic property and/or its at least one image processing property, in particular wherein the predetermined and stored expected behaviors are adapted based on the deviation, and/or
Newly self-learned behavior pattern for a set of objects, in particular in combination with its type, its at least one individual property, its at least one kinematic property and/or its at least one image processing property, in particular wherein the self-learned expected behaviors are adapted based on the deviation.

Constant or typical kinematic properties occur in particular if the door is actuated in a way that the door is not noticed by the person or has no influence on the movement of the person.

It can be said that if the person behaves like to door is always fully opened, i.e. it is not regarded as an obstacle whatsoever, the door is actuated in an optimal and friendly way.

In an embodiment, the prediction of the expected behavior and/or the actual behavior comprise information about the door usage by the respective object, the duration until the door is passed, a collision probability of the respective object with the door and/or direct feedback of the specific object, improving the accuracy of the prediction.

In order to improve the prediction of the expected behavior even further, the direct feedback may include, if the object is a person, the change of mood and/or gestures of the person and/or unexpected motions of the person, in particular directed at the door in front of the door, in the door and/or after having passed the door, acoustic feedback of the person, certain, predefined poses of the person, facial expressions of the person and/or motion of the person with objects the person is carrying in front of the door, in the door and/or after having passed the door.

In an embodiment, a rule set, in particular comprising rules and/or an evaluation logic, is stored in the measure module and/or the control unit, the rule set, in particular the rules and the evaluation logic, defining a plurality of conditions for whether or not an object present in the recording is to be considered for the determination of the measure and/or conditions for when a specific measure is to be taken. The measure module determines at least one object to be considered and/or the measure based on the rule set and the type of the at least one object recognized in the recording and/or its at least one individual property, its at least one kinematic property, its at least one image processing property and/or its expected behavior. By using the rule set, it is possible to define specific characteristics very granularly that persons, animals and/or objects must have to pass the door.

The conditions and/or rules may also take into account more than one object, its type and/or properties to differentiate between different situations. A condition may be that the door shall open for persons without shopping carts, i.e. the condition demands the presence of an object recognized as a person and the absence of objects recognized as shopping carts in the recording.

For example, the rule set comprises instructions, in particular definitions in the evaluation logic, that define whether and/or how the door shall be opened if more than one condition of the rule set is met, in particular if the conditions that are met are in conflict with one another. This way, it is possible to even handle complex situations in front of the door.

For example, the conditions include the presence or absence of a specific object, a specific type of object, a specific individual property, a specific kinematic property, a specific image processing property, an expected behavior, in particular whether the object is expected to pass the door, or any combination thereof so that different situations are easily distinguishable.

The presence and absence of the properties may be given in probabilities that the specific property is present or absent.

In order to resolve conflicts easily, the rule set may comprise instructions, in particular definitions in the evaluation logic, that define the measure that shall be taken if more than one condition of the rules is met, in particular if the conditions that are met are in conflict with one another.

In an embodiment, the rule set, in particular at least one of the conditions, rules, instructions and/or at least one of the measures is adapted based on the deviation. This way, the adaption by the adaption module may be performed easily by adapting rules.

In order to actuate the door specifically, the measure may comprise the controlling of the drive unit based on an actuation profile for achieving a desired movement of the door, in particular a desired movement of at least one door leaf of the door.

In an aspect of the invention, the actuation profiles are predetermined and/or the actuation profiles are created by the adaption module based on the deviation and/or by classifying common behaviors of certain objects, their type and/or their properties. This make the use of actuation profiles very easy.

The actuation profile may be selected based on the at least one object recognized in the recording and/or its type, its at least one individual property, its at least one kinematic property, its at least one image processing property, and/or its expected behavior, and/or an actuation profile may be created by the measure module based on the type of the at least one object recognized in the recording and/or its at least one individual property, its at least one kinematic property, its at least one image processing property, and/or its expected behavior. This way it is ensured that a suitable actuation profile is used.

Actuation profiles may be created from scratch or using a template.

In an embodiment, the selection of the actuation profile is adapted based on the deviation, at least one of the predetermined actuation profiles is adapted based on the deviation, and/or wherein the way the actuation profile is created by the measure module is adapted based on the deviation, allowing to directly adapt the door movement.

In order to precisely control the behavior of the door, the actuation profile may include the acceleration and the velocity of the door, in particular the door leaf, at various positions during the movement; the desired travelling distance; the duration between the start of the movement and reaching various predetermined positions, optionally including the time of the start of the movement; and/or a minimal distance between one of the at least one objects to the door, to the door leaf, to the track of the door and/or to the track of the door leaf and/or the physical capability of the door.

For example, the actuation profile includes the acceleration and the velocity of the door, in particular the door leaf, at various positions during its movement; the desired travelling distance; the duration between the start of the movement and reaching various predetermined positions, optionally including the time of the start of the movement; and/or a minimal distance between one of the at least one objects to the door, to the door leaf, to the track of the door and/or to the track of the door leaf, so that the desired door movement is represented, in particular represented entirely by the actuation profile.

The recording may be a captured single image, a captured series of consecutive images and/or a video recording. The images of the series of image are preferably consecutive.

In an aspect of the invention, the measure module takes additional situation data into consideration for determining the measure, the expected behavior and/or the actual behavior, in particular the additional data including current weather conditions, like ambient temperature, wind speed, air pressure, humidity, the temperature difference between opposite sides of the door, the air pressure difference between opposite sides of the door, the weekday, the time, the date, the type of the door, the geometry of the door and/or the configuration of the door. Using the additional situation data, the control of the door, the prediction and/or adaption are more precise.

In an embodiment, the measure module and/or the adaption module comprises an adaptive deterministic algorithm, a machine learning algorithm, a support vector machine and/or a trained artificial neural network, allowing efficient object recognition and/or adaption.

For a very well adapted recognition and/or adaption, the artificial neural network may be trained using training data, wherein the training data comprises, for various training situations, input data of the same type and structure as the data which is fed to the artificial neural network during regular operation of the door system, and information about the expected correct output of the artificial neural network for the training situations; the training comprises the following training steps:
feed forward of the input data through the artificial neural network;
determining an answer output by the artificial neural network based on the input data,
determining an error between the answer output of the artificial neural network and the expected correct output of the artificial neural network; and
changing the weights of the artificial neural network by back-propagating the error through the artificial neural network,

In case of the artificial neural network of the measure module the input data may include recordings captured by the camera; the information about the expected correct output may include information about the actual objects in the recording including their types as well as their individual, kinematic and/or image processing properties, the measure, the expected behavior, the actual behavior and/or the deviation; and the answer output may include the actual objects in the recording, their types, their properties and/or their individual, kinematic and/or image processing properties, the measure, the expected behavior, the actual behavior and/or the deviation determined based on the input data.

In case of the artificial neural network of the adaption module the input data may include recordings captured by the camera; the information about the expected correct output may include the expected behavior, the actual behavior, the deviation and/or the adaption of the measure module; and the answer output may include the expected behavior, the actual behavior, the deviation and/or the adaption of the measure module.

For above mentioned purpose, a system is provided comprising an analysis unit with a measure module and an adaption module, and an automatic door system having at least one door, at least one drive unit for actuating the at least one door, in particular at least one door leaf of the door, a camera and a control unit for controlling the drive unit, wherein the system is configured to carry out a method as explained above, in particular wherein the measure module is part of the door system, for example part of the control unit and/or controller of the camera.

The controller of the camera may be an image processing unit.

The features and advantages discussed in context of the method also apply to the system and vice versa.

For efficiently providing the recording and/or the additional measurement value, the camera may be a single camera, a stereo camera, a time of flight 3D camera, an event camera or a plurality of cameras; and/or the door system may comprise at least one additional situation sensor for acquiring the additional situation data, in particular a temperature sensor, a wind sensor, a humidity sensor, a pressure sensor, and/or an interface for receiving the additional situation data.

Further features and advantages will be apparent from the following description as well as the accompanying drawings, to which reference is made. In the drawings:

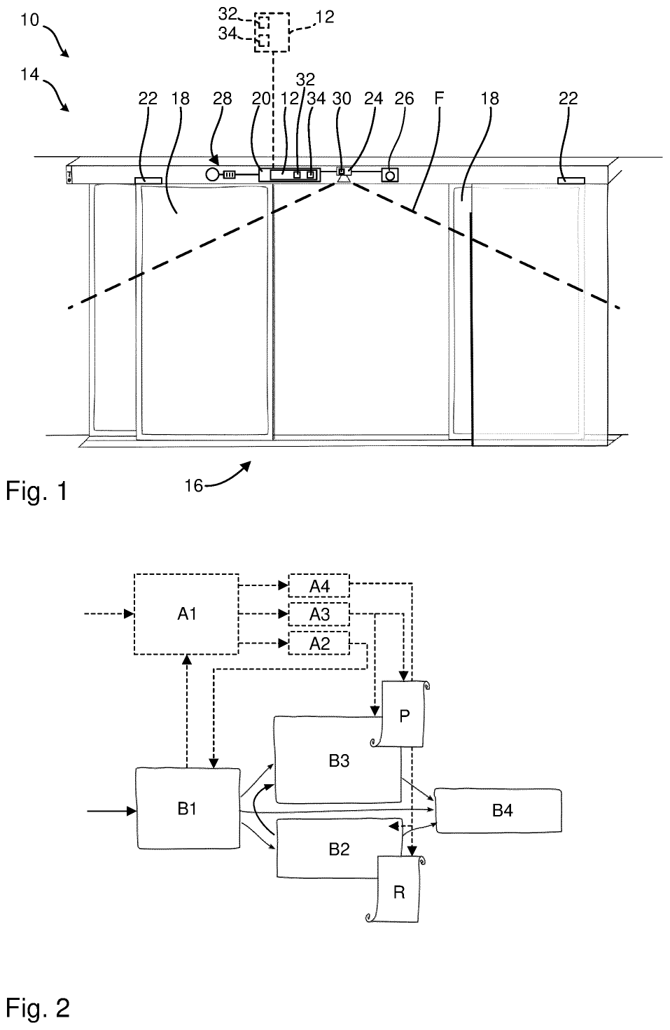

FIG. 1: shows a system according to the invention schematically,

FIG. 2: shows the different evaluation blocks involved in the method according to the invention,

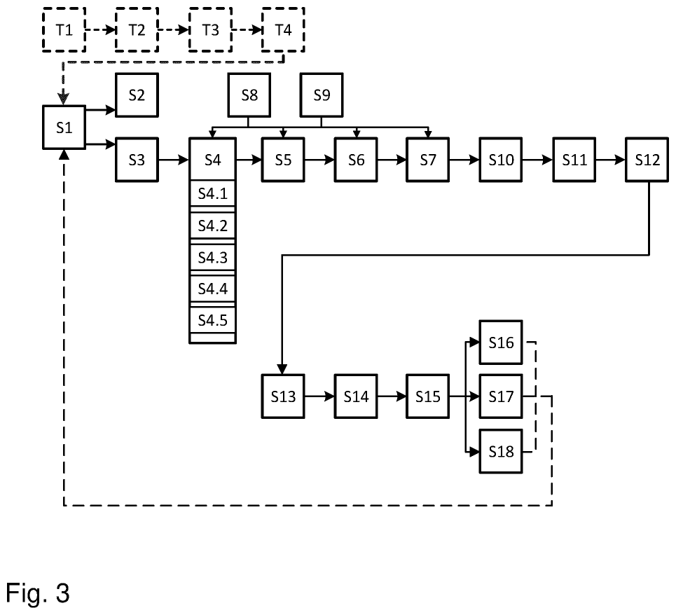

FIG. 3: shows a flowchart of the method according to the invention,

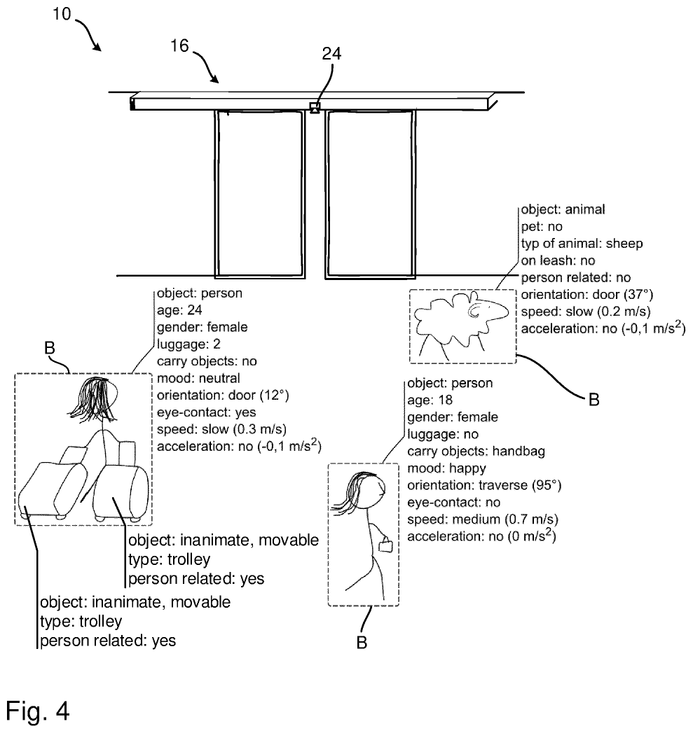

FIG. 4: shows a first situation during the operation of the system according to FIG. 1 carrying out parts of the method according to FIG. 3,

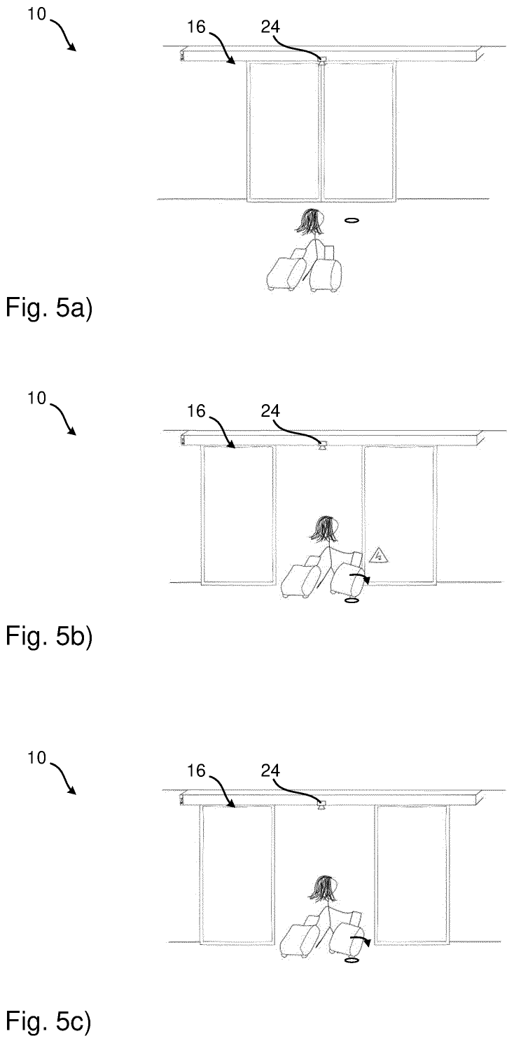

FIGS. 5a-c: show three states of a first situation during operation of the system according to FIG. 1 illustrating the effect of the adaption module in the method according to FIG. 3, and

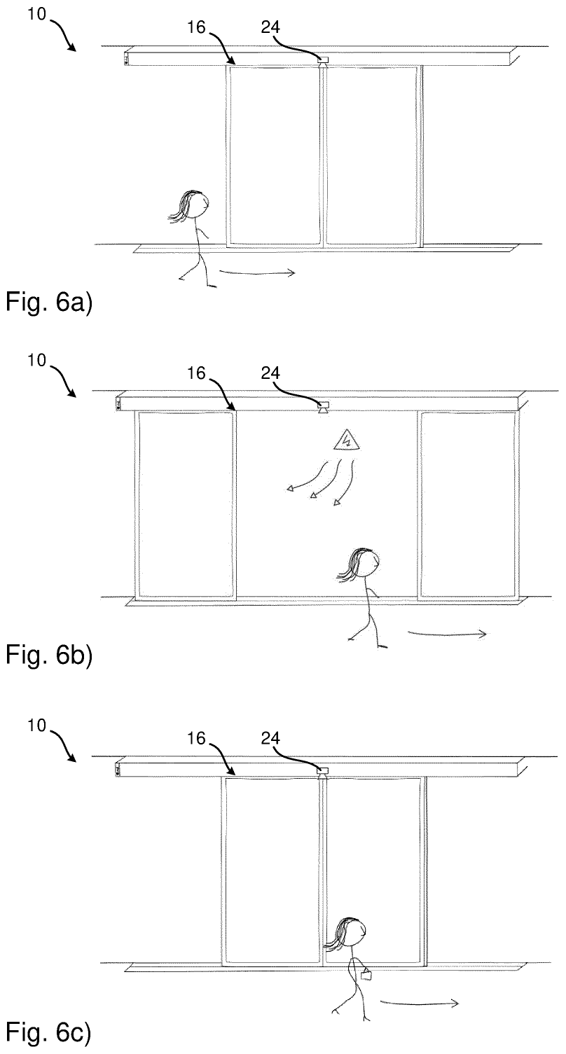

FIGS. 6a-c: show three states of a second situation during operation of the system according to FIG. 1 illustrating the effect of the adaption module in the method according to FIG. 3.

FIG. 1 shows schematically a system 10 according to the invention having an analysis unit 12 and an automatic door system 14.

The automatic door system 14 has a door 16, being a sliding door in the shown embodiment with two door leaves 18, a control unit 20, two drive units 22, and a camera 24. The automatic door system 14 may further comprise one or more additional situation sensors 26 and a signaling device 28.

The door 16 may as well be a swing door, a revolving door, a folding door or the like. The method of operation remains the same.

The camera 24 and the drive units 22 are connected to the control unit 20, wherein the control unit 20 is configured to control the drive units 22.

Each of the drive units 22 is associated with one of the door leaves 18 and is designed to move the respective door leaf 18 along a track. The door leaves 18 may be moved individually from one another.

In particular, the door leaves 18 are moveable such that between them a passage can be opened, wherein the width of the passage is adjustable by the control unit 20.

The camera 24 has a controller 30 and is located above the door 16, i.e. above the track of the door leaves 18.

The controller 30 may be an image processing unit of the camera 24.

The camera 24 is an integral part of the safety functionality of the door system 14. Namely, the camera 24 monitors the track of the door 16, i.e. the movement path of the door leaves 18, and forwards this information to the control unit 20 or its integrated controller 30. Based on this information, the integrated controller 30 and/or the control unit 20 control the drive units 22 to ensure that the door 16 is operated safely. In particular, to avoid that persons, for example vulnerable persons such as children or elderly people, present in the track of the door 16 are touched or even harmed by closing the door leaves 18.

The camera 24 may be a single camera, a stereo camera, a time of flight 3D camera an event camera or a plurality of cameras.

The field of view F of the camera 24 includes the track of the door 16, in particular the track of the door leaves 18.

The field of view F of the camera 24 may cover an area of up to 5 m, preferably up to 7 m, more preferably still up to 10 m in front of the door 16, measured on the ground. Thus, the field of view F includes, for example, the sidewalk of the street in front of the building the system 10 is installed in.

The analysis unit 12 comprises a measure module 32 and an adaption module 34, one or both being machine learning modules.

The analysis unit 12 in total or at least the measure module 32 may also be a part of the automatic door system 14. For example, the analysis unit 12 or the measure module 32 may be integrated into the control unit 20 or integrated into the controller 30 of the camera 24.

It is also conceivable that the analysis unit 12, in particular the adaption module 34, is separate from the door system 14. In this case, the analysis unit 12, in particular the measure module 32 and/or the adaption module 34, may be provided as a server (shown in dashed lines in FIG. 1), for example a server on premise or a cloud server, respectively.

It is also conceivable that the adaption module 34 is provided through a non-permanently attached entity i.e. such as a mobile device, a service tablet or a specific portable device. In this case, the adaption module 34 is connected to the measure module 32 only occasionally, for example using a wired or wireless data connection.

In any case, the analysis unit 12 is connected to the control unit 20 and/or the drive units 22.

The additional situation sensor 26 may be a distance sensor, like an infrared light source as known in the art, or a source of electromagnetic radiation, for example a radar.

The field of view of the additional sensor 26 overlaps with the field of view F of the camera 24.

The signaling device 28 may include an optical signaling device, like a light, and an acoustical signaling device like a speaker. The signaling device 28 may be mounted above the door 16.

The signaling device 28 may be a signaling device of the building in which the door system 14 is installed in.

The automatic door system 14 may also comprise a microphone to detect acoustic feedback from the persons passing the door 16.

FIG. 2 shows an illustration of evaluation blocks to determine, whether and how the door 16 shall be opened. FIG. 2 is for illustration purposes only and the blocks shown therein are not necessarily separate hardware and/or software modules.

For simplification, the inputs of the additional situation sensor 26 are not shown in FIG. 2.

In the first block B1, the recordings captured by the camera 24 are evaluated and classified. Objects in the recordings are recognized as will be explained in more detail below.

Further, an expected behavior is predicted based on the recognized objects and their properties, the details of which will also be explained later.

In block B2, the information generated in block B1 is evaluated based on rules R according to an evaluation logic. The rules R may be predefined and stored in a memory of the analysis unit 12.

Based on the rules R, a measure of door system 14 is determined. The measure may be seen as a reaction of the door system 14 to the situation recognized in front of the door 16. A measure may be that the door 16 is opened in a specific way but also that the door 16 is kept closed or open. In the latter case, no visible action or change of the door 16 occurs.

In block B3, the information, in particular the measure generated in the blocks B1 and/or B2 are used to select an actuation profile P.

The actuation profile P defines the movement that the door 16, in particular the door leaves 18 shall perform. For example, the actuation profile P includes the acceleration and the velocity of the door leaves 18 at various positions during the movement. Further, the actuation profile P may define the traveling distance for each door leaf 18, the duration between the start of the movement and reaching various predetermined positions during the movement. Further, the time of start of the movement can be defined, for example as “immediately”.

It is also possible, that the actuation profile defines a minimal distance between an object recognized in the recording and the door 16, in particular the door leaf 18 and/or the track of the door leaves 18, at which the movement of the door leaves 18 shall be initiated.

Further, the actuation profile P takes in to account the physical capabilities of the specific door 16 or door leaf 18, e.g. a maximum possible acceleration.

The actuation profiles P may be predefined and stored in the memory of the analysis unit 12. The actuation profile P is then selected based on the information generated in blocks B1 and/or B2. It is also possible, that the selected actuation profile P is adapted based on this information.

It is also conceivable that the actuation profile P is created based on the information of blocks B1 and B2, i.e. that no actuation profiles P are predetermined.

Then, in block B4, based on the selected actuation profile P of block B3 and optionally the information generated in blocks B1 and/or B2, the door 16, more precisely the door leaves 18 are actuated by the drive units 22. To this end, the drive units 22 receive steering input from the control unit 20 and/or the analysis unit 12 based on the actuation profile P. The actuation profile P may also be of the kind that no movement of the door 16 is carried out, e.g. in the case that the door 16 shall be kept closed or open.

In particular block B1 and optionally also block B2 and/or block B3 are carried out by the analysis unit 12, in particular the measure module 32.

After the door 16 has been actuated, the camera 24 keeps capturing one or more recordings which are evaluated in the in block A1. The actual behavior of the objects in the recording after the door 16 has been actuated is recognized.

The actual behavior is compared to the expected behavior predicted in block B1 and a deviation between the actual behavior and the predicted expected behavior is determined.

It shall be noted that the expected and the predicted behavior may or may not include estimates of the properties of an object, in particular dimensions of an object.

Then, in block A2 the deviation is used to adapt the prediction carried out in block B1; in block A3 the deviation is used to adapt the actuation profiles P or create new actuation profiles P of block B3; and/or in block A4 the deviation is used to adapt the rules R or create new rules R evaluated in block B2.

Blocks A2, A3 and A4 are carried out by the adaption module 34. Block A1 may also be carried out by the adaption module 34, wherein it is possible that the actual behavior is recognized by the measure module 32 and/or the comparison is carried out by the measure module 32.

To this end the analysis unit 12, in particular the measure module 32 and/or the adaption module 34 comprise a deterministic algorithm, a machine learning algorithm, a support vector machine and/or a trained artificial neural network.

The measure module 32 and the adaption module 34 may have separate deterministic algorithms, machine learning algorithms, support vector machines and/or trained artificial neural networks. In particular, the adaption module 34 may have a plurality of deterministic algorithms, machine learning algorithms, support vector machines and/or trained artificial neural networks.

FIG. 3 shows a more detailed flowchart of the method according to the invention than the overview of FIG. 2.

During operation, in a first step S1, the camera 24 captures recordings. The recordings are, for example, recordings of a single image, recordings of a series of consecutive images and/or a video recording.

For example, recordings are captured in regular intervals, in particular continuously, and the following steps are carried out for multiple recordings simultaneously. In particular, the steps are carried out for each recording and/or each frame of a recording improving reaction time of the system 10.

The recordings include the field of view F, and thus the track of the door 16, the area in front of the door 16 as well as the area shortly behind the door 16. Further, the field of view includes all the objects or persons present therein.

The recordings are used on the one hand for ensuring a safe operation of the door 16. The control unit 20 or the integrated controller 30, which receives the recordings, ensures that-based on at least the part of the recording showing the track of the door-the door 16 is operated safely. In particular, it can be avoided that persons for example vulnerable persons such as children or elderly people, that are present in the track of the door 16 are touched or even harmed by the door leaves 18. To this end, the control unit 20 and/or the integrated controller 30 controls the drive unit 22 to actuate the door leaves 18 accordingly (step S2). This way, the door 16 can be operated safely. Thus, the camera 24 is an integral part of the safety functionality of the door 16.

On the other hand, in step S3, the recordings are transmitted to the analysis unit 12.

In step S4, the measure module 32 of the analysis unit 12 performs image recognition. Firstly, in step S4.1 the analysis unit 12 recognizes the objects and the types of the objects in the recording.

The recognized objects may be persons, animals, movable objects or stationary objects.

Movable objects are, for example, inanimate objects that may be carried by a person, like a purse, a dog or a backpack. They also may be rolling, pushed or pulled by a person, like a stroller, bicycle or a trolley. Thus, these objects can also be associated with a person. Further, movable objects may also be self-propelled, like an e-scooter or a car.

Stationary objects may be plants, permanent signs or the like.

The analysis unit 12 may also recognize kinematic properties of the objects in the recordings (step S4.2).

Thus, the analysis unit 12 may for each object in the recording determined the position of the object with respect to the door 16, the change of position, the velocity, the change of velocity, the acceleration, the change of acceleration, the distance to the door and/or the direction of movement of the object.

Of course, all of these values may be determined for each spatial direction separately. In particular, for each object two spatial directions are relevant, namely the two spatial directions parallel to the ground. Thus, for example, a two dimensional vector is determined for each of the above mentioned kinematic properties for each object.

In particular, the analysis unit 12 determines the kinematic property of a kinematic subpart of an object which is a part of an object that may move in addition to the general movement of the object. Examples are the skeleton function of a human or an animal, a body part of a human or animal, like an arm, a leg or the head, or parts of an object extending from the main part of the object, like the handlebar of a bicycle. For the ease of understanding, kinematic properties of a kinematic subpart are also meant when referring to the kinematic properties of the object.

The type of the object is also recognized, for example the objects are classified as “person”, “dog”, “stroller”, “trolley”, “bicycle”, “plant”, “e-scooter” and/or “car” (step S4.3).

Further, the analysis unit 12 recognizes various individual properties of each of the objects in the recording (step S4.4). The recognized individual properties may differ depending on the type of the object.

For example, if the object is a person, the individual properties may include the age, the size, the ethnicity, the clothes worn by the person, the items and/or objects carried by the person, the type of locomotion (walking aid, inline skates, skateboard, etc.), the orientation with respect to the door, the pose of the person, the viewing direction of the person, the level of attention of the person, the state of health of the person, the mood of the person, the current activity of the person, a gesture, if any, performed by the person, the behavior of the person, the gait of the person and/or the posture of the person.

If the object is an animal, the analysis unit determines the species of the animal, the breed of the animal, whether the animal is a pet, whether the animal carries prey, whether the animal is on a leash and/or whether the animal is wearing a muzzle.

If the object is a movable object, the analysis unit 12 may determine whether the object is associated with and/or carried by a person.

Further, the analysis unit 12 may determine for each object in the recording image processing properties in step S4.5.

Image processing properties are properties of the object that are used for the purposes of image processing and simplification. For example, image processing properties may be the bounding box B of each object, the closure of objects, in particular of fused objects, the time limit of properties of an object and/or the fusion of an object with other objects.

Thus, the measure module 32 recognizes each object in the recording, their types as well as their individual, kinematic and/or image processing properties.

In step S5, the measure module 32 predicts the behavior of the object, in particular each movable object in the recording. The predicted behavior will be called expected behavior in this disclosure as the system 10 expects the object to behave as predicted.

The expected behavior includes various parameters for describing the future behavior of the object. The parameters include, for example, information about the door usage, i.e. whether or not the object will or intends pass the door; the duration until the door is passes, i.e. the estimated time of arrival at the track of the door; whether or not the object will collide with the door 16; and/or, in case the object is a person, direct feedback of the specific person, for example the change of mood of the person, the gesture or unexpected movements of the person directed at the door in front of the door, in the door and/or after having passed the door, acoustic feedback of the person, specific predefined poses of the person, facial expressions of the person and/or motions of the persons with objects he or she is carrying in front of the door, in the door and/or after having passed the door.

In particular, for the question whether or not the object will pass the door 16 and/or whether the object will collide with the door 16, the respective parameter is a probability value indicating the collision probability and the probability the object will pass the door 16, respectively. Any other one of the parameters may also be given as a respective probability value.

To determine the expected behavior, for example, a continuation of the behavior of the object is assumed, meaning that the current kinematic properties are assumed as constant for the future. It is also possible that the kinematic properties for the future are assumed to be properties that typically occur, for example, if a step is present in front of the door 16, it is typical that objects will slow down in the region of the step.

For example, the continuation of the behavior is expected even after the door 16 has been actuated, particularly until the object passes the door 16. In other words, it is assumed that the actuation of the door 16 does not lead to a change of the kinematic properties. Such an actuation of the door 16 that does not interfere with an object or person at all, is also called “friendly actuation” or “friendly door behavior”.

In addition or alternatively, a plurality of expected behaviors may be predetermined and stored for various objects, in particular in combination with its type, its at least one individual property, its at least one kinematic property and/or its at least one image processing property.

The expected behavior is then selected for the specific object in the recording and may be adapted slightly to fit the properties of the object, in particular the kinematic properties.

It is also conceivable that the expected behavior is a self-learned behavior pattern for a set of objects. In contrast to the predetermined expected behaviors mentioned above, the self-learned behavior patterns are created by the adaption module 34 during the operation of the door system 14. However, much in the same way, the self-learned behavior patterns are chosen in combination with the type of the object in question, its at least one individual property, its at least one kinematic property and/or its at least one image processing property.

In total, steps S4 and S5 correspond to block B1 of FIG. 2 and the objects, their types as well as their individual, kinematic and/or image processing properties as well as the expected behavior correspond to the information generated in block B1.

In the next step S6, the analysis unit 12 and/or the control unit 20 determine a measure of the door 16, in particular whether the door 16 shall be opened based on a rule set.

The rule set comprises the plurality of rules R and also an evaluation logic according to which the rules R are to be applied, in particular in case of a conflict.

The rule set is stored in the measure module 32 or the control unit 20, respectively. The rule set may be predefined and/or adapted by the adaption module 34.

The rules R define a plurality of conditions when an object in the recording is to be considered for the determination of a measure and/or when a measure is to be taken, e.g. whether the door 16 shall be opened, shall stay open, shall stay closed or shall be closed.

Each rule R includes conditions concerning the presence or the absence of a specific object, a specific type of object, a specific individual property, a specific kinematic property, a specific image processing property or a combination thereof. Further, each rule R comprises the consequence or measure of the conditions, i.e. whether the door shall be opened or not.

The probability of above parameters may be determined, i.e. the probability that a specific object is present, and the conditions are based on these probabilities.

Simple examples of rules may be that only the presence of a person, i.e. not the presence of objects or animals, leads to opening of the door.

Another example is that only persons without luggage shall open the door, meaning that the presence of a person not associated with objects of the type trolleys, luggage or the like leads to opening of the door.

A further example may be that only animals on a leash shall open the door, meaning that the presence of a person and the presence of an animal having the additional individual property that they are held on the leash, lead to the consequence that the door shall be opened.

It is also possible, that one rule R takes into account more than one object, its types and/or properties to differentiate between different situations.

A condition or rule may be that the door shall open for persons without shopping carts, i.e. the rule R demands the presence of an object recognized as a person at the absence of objects recognized as shopping carts in the recording, before the door shall be opened.

It is of course possible, that more than one object is present in the recording that fulfill conditions of different rules R but that the consequence of these rules R are contradicting to one another, meaning that one rule indicates that the door shall be opened based on one of the objects in the recording and another rule indicates that the door shall stay closed based on other objects in the recording.

To resolve these issues, the evaluation logic comprises instructions that define whether and/or how the door shall be opened if more than one condition of the rule set, i.e. more than one rule R, is met.

This way, the control of the door 16 may be based on more than one object recognized in the recording.

If it has been determined in step S6, which corresponds to block B2, that the door shall be moved, it has to be decided, how the door shall be moved. This is done in step S6, also by the measure module 32 or the control unit 20, respectively.

Based on the objects recognized in the recording that have been considered by the rules R in the decision to open the door, their types, their individual properties, their kinematic properties and/or their image processing properties, an actuation profile P-being part of the measure-is selected, created or adapted in step S7. In particular, the kinematic properties of the objects relevant for this specific rule R are taken into consideration for the selection, creation or adaption of the actuation profile P.

The measure module 32 may also create an actuation profile P based on a template of actuation profiles or from scratch.

For example, if the speed of a person approaching the door is high, then the door 16 has to open more quickly than in cases where the speed is rather low. Further, if a person carries bulky luggage or pulls trolleys, the door 16 has to be opened wider than for the person alone.

Thus, the desired movement of the door leaves 18 depends on the objects and the overall situation.

Step S7 thus corresponds to block B3 of FIG. 2.

It is conceivable that already the rules R indicate a measure, in particular a specific actuation profile P that shall be selected or adapted.

The determination of the measure, i.e. steps S6 and S7, may be carried out simultaneously with or after the determination of the expected behavior (step S5).

It is possible that in step S4, S5, S6 and/or S7 measurement values from the additional situation sensors 26 are considered.

As an illustration, in step S8 the distance to one or more of the objects is determined and transmitted to the analysis unit 12 for the control unit 20, respectively.

Then the analysis unit 12 or the control unit 20, respectively, takes the measurement values into consideration for the recognition of objects, type and properties (step S4), the prediction of the expected behavior (step S5), determining whether the door shall be opened (step S6) and/or for the determination of the actuation profile (step S7).

Likewise, in step S9, it is conceivable that the analysis unit 12 or the control unit 20, respectively, takes the additional situation data into consideration for the recognition of objects, type and properties (step S4), the prediction of the expected behavior (step S5), the determination whether the door shall be opened (step S6) and/or for the determination of the actuation profile (step S7).

The additional situation data may be generated by the camera 24, for example as an additional distance measurement, or from the control unit 20 being the state of the door, the current number of persons within the building, the current weather conditions, like ambient temperature, wind speed, air pressure, humidity, the temperature difference between opposite sides of the door 16, the air pressure difference between opposite sides of the door 16, the weekday, the time, the date, the type of the door 16, the geometry of the door 16 and/or the configuration of the door 16.

In particular, if the state of the door indicates that the door is already open, another actuation profile P has to be chosen than in cases where the door is closed.

It is also conceivable that the results of steps S4, S5, S6 and/or S7 are transmitted to the control unit 20 or the integrated controller 30 to be taken into consideration for ensuring the safe operation of the door 16.

Further, steps S2 to S9 do not have to be carried out in the order explained above but may be carried out in any other order. It is also possible that one or more of the steps S3 to S9 is omitted.

In the following step S10, the drive unit 22 is controlled by the analysis unit 12, in particular the measure module 32, or the control unit 20, respectively, according to the determined measure, for example based on the selected, created or adapted actuation profile P.

In step S11, the drive units 22 then actuate the respective door leaves 18 associated with them. Thus, the measure, for example the desired movement of the door 16 as defined in the actuation profile P is actually carried out by the door 16.

Steps S10 and S11 correspond to block B4 of FIG. 2.

Further in step S12, the signaling device 28 is actuated by the analysis unit 12 or the control unit, respectively, based on the recognized object, the type of the object, at least one property of the object, its individually kinematic and/or imaging processing property. For example, the actuation profile P or the rule R may already indicate, whether the signaling device 28 shall be activated and how.

For example, the signaling device 28 may be activated if an object is denied entrance, e.g. if a person has attempted to enter the door 16 but no rule R for opening the door matches this particular person and properties.

The signaling device 28 could also be used, to indicate the position of the door to a person that is allowed to enter the door 16.

After the measure has been carried out-which could also be that no visible action has been performed-the actual behavior of the object or objects that has or have led to the measure is/are recognized. For the sake of simplicity only, in the following only the singular will be used.

In step S13 a recording is captured again after the measure has been determined or carried out. In particular, the recording has been captured continuously without intermissions.

Then, in step S14, similarly to steps S4 and S5, the behavior of the object or the person is determined which corresponds to the actual behavior of the object or person in reaction to the measure and is therefore referred to as the “actual behavior” in this disclosure.

Step S14 may be carried out by the measure module 32. It is also conceivable that the adaption module 34 received the recordings and carries out steps S14.

Similar to the expected behavior, the actual behavior may include various parameters for describing the past behavior of the object. The parameters include, for example, information about the door usage, i.e. whether or not the object has passed through the door; the duration until the door has been passed, i.e. the time of arrival at the track of the door 16; whether or not the object has collided with the door 16; and/or, in case the object is a person, direct feedback of the specific person, in particular in an area behind the door 16, for example the mood of the person, the gesture or unexpected movements of the person directed at the door, acoustic feedback of the person, specific predefined poses of the person, facial expressions of the person and/or motions of the persons with objects he or she is carrying. In particular, the change of mood can be used as a direct feedback.

Having determined the actual behavior, in step S15 the adaption module 34 then compares the previously predicted expected behavior of the object with the actual behavior of the object. The comparison yields a deviation of the actual behavior from the expected behavior (cf. block A1).

The deviation is an indicator of the quality of various steps that have been carried out, for example the prediction of the expected behavior and the suitability of the measure that has been carried out.

Thus, the deviation is then used by the adaption module 34 to adapt the measure module 32 to improve the measures for future operation.

In step S16, corresponding to block A2, the adaption module 34 adapts the way that the measure module 32 predicts the expected behavior based on the deviation, in particular the artificial neural network of the measure module 32 responsible for the prediction of the expected behavior is adapted.

It is also possible that the adaption module 34 adapts the predetermined expected behavior stored in the measure module 32 for the specific object based on the deviation.

Further, the adaption module 34 may recognize behavior patterns for sets of objects, e.g. persons with walking aids, based on a plurality of past actual behaviors of objects belonging to the set of objects. The adaption module 34 then creates a self-learned behavior pattern for the set of objects and the self-learned behavior pattern is then transferred to the measure module 32 for further use during prediction.

In step S17, corresponding to block A3, based on the deviation, the adaption module 34 adapts the actuation profile P used that has led to the actual behavior or actuation profiles P similar thereto. The actuation profile P is adapted on the measure module 32 or an adapted version of the actuation profile P is transferred to the measure module 32.

Further, the adaption module 34 may—based on the deviation—adapt the way that the measure module 32 selects, creates and adapts actuation profiles. For example, the adaption module 34 may adapt the templates of the measure module 32 used to create actuation profiles.

It is also conceivable that the adaption module 34 creates new actuation profiles P based on the deviation. The adaption module 34 may also create new actuation profiles P by classifying common behaviors of certain objects, their type and/or their properties based on the actual behaviors that have been determined during operation by the door system 14. To this end, it is also possible that the adaption module 34 makes use of determined actual behaviors received from other similar door systems 14.

The new actuation profiles P are created in the measure module 32 or transferred to the measure module 32.

In step S18, corresponding to block A4, based on the deviation, the adaption module 34 adapts the rule set, in particular a rule R, a condition, an instruction and/or a measure defined in a rule that has or have been causal for the determination of the measure that has led to the actual behavior. The rule set may be adapted on the measure module 32 or an adapted rule set is transferred to the measure module 32.

Further, the adaption module 34 may-based on the deviation-adapt the way that the measure module 32 selects, creates and adapts rules R.

Steps S16, S17 and S18 may be carried out simultaneously.

The determination of a measure, i.e. steps S1 to S9, may be carried out for each recording, even in short succession or simultaneously and even if the measure has not been carried out yet. For example, in case of a video as the recording the measure may be determined for each frame of the video. Thus, a measure that has been determined but not yet carried out may be changed because a different measure has been determined based on a recording captured later in time.

FIG. 4 shows a situation of the system 10 in use.

In this situation, five objects are within the field of view F of the camera 24, namely two female persons, two trolleys and one sheep.

On the left-hand side, as indicated in FIG. 4, the measure module 32 recognizes a female person (first object) of age 24 in neutral mood who is walking at a slow speed of 0.3 m/s and slightly decelerating at the door 16. She is oriented towards the door at an angle of 12° (with respect to a line perpendicular to the track of the door 16). The person has eye contact with the door. The measure module 32 also recognizes the bounding box b—shown in a dashed line in FIG. 4—as an image processing property.

For example, regarding the first object the measure module 32 recognizes the following: “object: person; age: 24; gender: female; luggage: 2; carry objects: no; mood: neutral; orientation: door (12°); eye-contact: yes; speed: slow (0.3 m/s); acceleration: no (−0.1 m/s²)”.

Further, the measure module 32 recognizes two movable objects (second object and third object) as trolleys that are pulled by the person. Thus, the two objects are associated with the person.

For example, regarding the second and third object the measure module 32 recognizes the following for each object: “object: inanimate, movable; type: trolley; person related: yes”.

Further, a second person (fourth object) in the middle is walking parallel to the door. The measure module 32 recognizes this object as a person of female gender and age 18. The person carries a handbag and appears happy. The measure module 32 also determines that the orientation of the person is traverse to the door and that she has no eye contact with the door. Also the kinematic properties of 0.7 m/s walking speed and no acceleration are recognized.

For example, regarding the fourth object the measure module 32 recognizes the following: “object: person; age: 18; gender: female; luggage: no; carry objects: handbag; mood: happy; orientation: door (95°); eye-contact: no; speed: medium (0.7 m/s); acceleration: no (0 m/s²)”.

Further, the fifth object is an animal right in front of the door. The animal is a sheep and thus not a pet. It is further not on a leash or not related to any person. It is oriented at the door and walks at a slow speed of 0.2 m/s and decelerates slightly.

For example, regarding the fifth object the measure module 32 recognizes the following: “object: animal; pet: no; type of animal: sheep; on leash: no; person related: no; orientation: door (37°); speed: slow (0.2 m/s); acceleration: no (−0.1m/s²)”.

The measure module 32 predicts the expected behavior of the object, namely that the women on the left hand side is likely to pass through the door with her trolleys, that the women in the middle is walking by the door and that the sheep keeps moving in the same direction.

In this situation, the person in the middle traversing the door does not have any influence on the door behavior as she is not interested in entering the building. Consequently, the measure module 32 does not take this person into account further.

The sheep in front of the door fulfills the conditions of a rule R that does not allow animals to enter the building. Thus, this rule would result in the door not being opened. However, the person on the left-hand side walking towards the door with two trolleys fulfills the condition of another rule R that indicates that the door 16 shall be opened.

The results of both rules R are in contradiction to one another so that an instruction in the evaluation logic to resolve the conflict have to be regarded by the measure module 32.

In this case, the instructions define that persons are allowed to enter the building even though animals are present in front of the door. Thus, the rule R associated with the person on the left-hand side is regarded more important. Therefore, according to this rule R for the person on the left-hand side and its properties an actuation profile P is selected.

Due to the fact that the person is pulling two trolleys, an actuation profile P for persons with luggage is selected that leads to a wide opening width of the door 16. Further, it is possible that the measure module 32 adapts this actuation profile P based on the estimated width of the person and the two trolleys to further increase the resulting opening width of the door 16 so that the person with the two trolleys can safely pass the door without the chance of collisions with one of the door leaves 18.

In the cases that the measure module 32 and/or the adaption module 34 make use of an artificial neural network, the artificial neural network is trained using training data for its specific purpose.

The training data comprises sets of different input data for various situations, for example situations as explained above, and also information about the desired door movement in each of the situations.

The input data includes the same type and data structure as supplied to the artificial neural network during the operation of the artificial neural network as explained above.

In particular, for the artificial neural network of the measure module 32 and for an artificial neural network of the adaption module 34, the input data includes recordings generated by the camera 24 and optionally the at least one measurement value extracted from the data of the camera 24 and/or at least one measurement value of at least one additional situation sensor 26.

Further, the input data includes the expected correct output of the artificial neural network in response to each data set of the input data.

In case of the artificial neural network of the measure module 32 the expected correct output includes information about the actual objects in the recording including their types as well as their individual, kinematic and/or image processing properties, the measure, the expected behavior, the actual behavior and/or the deviation.

In case of the artificial neural network of the adaption module 34 the expected correct output includes the expected behavior, the actual behavior, the deviation and/or the adaption of the measure module.

For the training of the artificial neural network, in a first training step T1 (FIG. 3) the input data is fed forward through the respective artificial neural network.

Then, the answer output of the respective artificial neural network is determined (step T2).

In case of the artificial neural network of the measure module 32 the answer output may include the actual objects in the recording, their types, their properties and/or their individual, kinematic and/or image processing properties, the measure, the expected behavior, the actual behavior and/or the deviation determined based on the input data.

In case of the artificial neural network of the adaption module 34 the answer output may include the expected behavior, the actual behavior, the deviation and/or the adaption of the measure module 32.

In step T3, an error between the answer output of the respective artificial neural network and the expected correct output (known from the training data) is determined.

In step T4, the weights of the respective artificial neural network are changed by back propagating the error through the respective artificial neural network.

Thus, the training may be used for all the blocks A1, A2, A3, A4, B1, B2 and/or B3 and/or as the basis for steps S2 to S9.

FIGS. 5a to 5c show three situations of a first scenario to illustrate the function of the adaption module 34.

In this scenario, only one person pulling two trolleys is present for simplification. The method would work the same way if more objects were present.

Also for simplicity, the properties of the person correspond to the properties of the person on the left hand side in the situation shown in FIG. 4.

In the situation in FIG. 5a, the person is in front of the door 16. The measure module 32 determines the object and its properties as explained with respect to FIG. 4. The expected behavior of the person determined by the measure module 32 is that the person will pass the door 16 without problems. The measure module 32 assumes that the door 16 will be opened wide enough for the woman and her two trolley to pass at the estimate time of arrival of the person at the track of the door 16. The measure module 32 chooses to open the door 16 rather slowly according to a suitable actuation profile P.

In FIG. 5b, the person passes through the door. However, the door 16 has been opened rather slowly and the opened passage is not yet wide enough for the right one of the two trolleys since the right trolleys has tilted to the right (indicated by the arrow in FIG. 5b) due to an unevenness in front of the door 16. Thus, the right one of the trolleys collides with the right door leaf 18 (indicated by the triangle in FIG. 5b).

When determining the actual behavior, the adaption module 34 recognizes the collision in the actual behavior which has not been part of the expected behavior since the door had been opened wide enough for a normal movement of a person with the two trolleys. The comparison between the expected and the actual behavior includes then, of course, the collision which should not have taken place.

Accordingly, the adaption module 34 then an adapts the measure module 32 based on the deviation to avoid such a collision in the future. For example, the adaption module 34 adapts the previously selected actuation profile P in this regard that the door 16 is opened more quickly and/or wider or the adaption module 34 creates a new actuation profile P for this case with a quicker door and/or movement.

The adaption module 34 may also adapt the way that the measure module 32 chooses and/or adapts the actuation profiles P in these cases.

In a similar future situation, shown in FIG. 5c, the measure module 32 then uses an activation profile P that leads to a quicker door movement, because of the adaption that had been taken place earlier. Thus, the door 16 is opened quickly and wide enough so that the person can pass the door 16 with her trolleys without a collision, even though the right trolley has also tilted to the right.

Thus, the behavior of the door 16 has been adapted to the very specific circumstances, i.e. the unevenness of the floor in front of the door 16, at the location the door 16 is installed at.

FIGS. 6a to 6c show three situations of a second scenario further illustrating the function of the adaption module 34.

Also in this scenario, only one person is present for simplification. The method would work the same way if more objects were present.

Also for simplicity, the properties of the person correspond to the properties of the second person in the middle in the situation shown in FIG. 4, but closer to the door 16.

In FIG. 6a, the person is walking almost parallel to the door. The measure module 32 recognizes the object as a women and determines the properties of the object as explained above.

Further, in the case of FIG. 6a, the measure module 32 predicts the expected behavior of the women such that the expected behavior includes the that the women intends to pass through the door 16.

In addition or alternatively, the measure module 32 then applies a rule R that indicates the measure that the door 16 shall open.

Thus, the measure module 32 selects, generates and/or adapts an actuation profile P to open the door 16 and the door 16 is opened accordingly.

As can be seen in FIG. 6b, the women did not intend to pass through the door 16 but walks by the opened door 16. Thus, the door 16 has been opened without need and, for example, warm air from the interior of the building escapes into the environment (indicated by the triangle in FIG. 6b).

Then, as the camera 24 keeps recording, the adaption module 34 recognizes the actual behavior of the women in the recording. The actual behavior recognized by the adaption module 34 includes that the women has walked by the door.

The comparison of the actual behavior with the previously determined expected behavior yield the deviation that the women has not passed through the door 16 but walked by.

Based on the deviation, the adaption module 34 then adapts the measure module 32 so that in these situations the measure will be that the door 16 stays closed.

To this end, the adaption module 34 may adapt the way that the measure module 32 predicts the expected behavior so that the expected behavior for a person approaching the door 16 in the same or similar manner will be in the future that the persons will walk by.

Alternatively or in addition, the adaption module 34 may adapt the rule R that had been applied by the measure module 32 and/or the adaption module 34 will create a new, more specific rule R for these cases so that the door 16 will stay closed.

It is also possible in situations with more than one object that the adaption module 34 adapts the instructions.

Thus, in similar future situations, as shown in FIG. 6c for example, the system 10 behaves differently.

In the future, when a person approaches the door 16 similar to the situation shown in FIG. 6a, the measure module 32 predicts that the person will walk by and/or a rule will indicate the measure that the door 16 shall stay closed, because of the adaption that had been taken place earlier.

Thus, as can be seen in FIG. 6c, for another person (holding a purse) in the future, the door 16 stays closed as the person walks by. Therefore, for example, the energy efficiency of the building is increased as heated air does not leave the building unnecessarily.

In summary, the method and the system 10 can provide the possibility of controlling the access to a building or other confined space in a very detailed and precise manner without the need for further personnel or other structures. Further, the system 10 adapts to situations during it operation time to improve the quality of service of the door, even in situations that are specific for the location the door 16 is installed in.

1. Method for operating an automatic door system (14) using an analysis unit (12), wherein the door system (14) comprises at least one door (16), at least one drive unit (22) for actuating the at least one door (16), a camera (24) and a control unit (20) for controlling the drive unit (22), wherein the analysis unit (12) comprises a measure module (32) and an adaption module (34), and wherein the method comprises the following steps:
capturing at least one recording by the camera (24), wherein the recording includes at least the area in front of the door (16),
transmitting the recording to the analysis unit (12),
recognizing at least one object by the analysis unit (12),
determining a measure based on the at least one recognized object and an expected behavior of the object using the measure module (32),
controlling the drive unit (22) according to the determined measure,
continuing to capture the recording after the measure has been determined,
recognizing the actual behavior of the object in the recording after the drive unit (22) has been controlled according to the determined measure,
determining a deviation of the actual behavior of the object from an expected behavior of the object, and
adapting the measure module (32) based on the deviation by the adaption module (34).

2. Method according to claim 1, characterized in that the measure is determined based on at least one individual property of the at least one object in the recording, based on at least one kinematic property of the at least one object in the recording, particularly a kinematic property of a kinematic subpart of the at least one object, and/or based on at least one image processing property of the at least one object in the recording, in particular wherein the kinematic property of the at least one object is the change of position, the velocity, the change of velocity, the acceleration, the change of acceleration, the position, the distance to the door and/or the direction of movement of the object and/or of its kinematic subpart.

3. Method according to claim 1, characterized in that the expected behavior is predicted by the measure module (32) prior to and/or during the determination of the measure, in particular wherein the adaption module (34) adapts the way the measure module (32) predicts the expected behavior based on the deviation.

4. Method according to claim 1, characterized in that the expected behavior is:
a continuation in the behavior of the object, in particular with constant and/or typical kinematic properties of the object prior to and after the control of the drive unit (22), in particular when the object passes through the door (16); and/or
predetermined and stored for an object, in particular in combination with its type, its at least one individual property, its at least one kinematic property and/or its at least one image processing property, in particular wherein the predetermined and stored expected behaviors are adapted based on the deviation, and/or
Newly self-learned behavior pattern for a set of objects, in particular in combination with its type, its at least one individual property, its at least one kinematic property and/or its at least one image processing property, in particular wherein the self-learned expected behaviors are adapted based on the deviation.

5. Method according to claim 1, characterized in that the prediction of the expected behavior and/or the actual behavior comprise information about the door usage by the respective object, the duration until the door is passed, a collision probability of the respective object with the door and/or direct feedback of the specific object.

6. Method according to claim 5, characterized in that the direct feedback includes, if the object is a person, the change of mood and/or gestures of the person and/or unexpected motions of the person, in particular directed at the door in front of the door, in the door and/or after having passed the door, acoustic feedback of the person, certain, predefined poses of the person, facial expressions of the person and/or motion of the person with objects the person is carrying in front of the door, in the door and/or after having passed the door.

7. Method according to claim 4, characterized in that a rule set, in particular comprising rules (R) and/or an evaluation logic, is stored in the measure module (32), the rule set, in particular the rules (R) and the evaluation logic, defining a plurality of conditions for whether or not an object present in the recording is to be considered for the determination of the measure and/or conditions for when a specific measure is to be taken, wherein the measure module (32) determines at least one object to be considered and/or the measure based on the rule set and the type of the at least one object recognized in the recording and/or its at least one individual property, its at least one kinematic property, its at least one image processing property and/or its expected behavior.

8. Method according to claim 7, characterized in that the conditions include the presence or absence of a specific object, a specific type of object, a specific individual property, a specific kinematic property, a specific image processing property, an expected behavior, in particular whether the object is expected to pass the door, or any combination thereof.

9. Method according to claim 7, characterized in that the rule set comprises instructions, in particular definitions in the evaluation logic, that define the measure that shall be taken if more than one condition of the rules is met, in particular if the conditions that are met are in conflict with one another.

10. Method according to claim 8, characterized in that the rule set, in particular at least one of the conditions, rules, instructions and/or at least one of the measures is adapted based on the deviation.

11. Method according to claim 1, characterized in that the measure comprises the controlling of the drive unit (22) based on an actuation profile (P) for achieving a desired movement of the door (16), in particular a desired movement of at least one door leaf (18) of the door (16).

12. Method according to claim 11, characterized in that the actuation profiles (P) are predetermined and/or that the actuation profiles (P) are created by the adaption module (34) based on the deviation and/or by classifying common behaviors of certain objects, their type and/or their properties.

13. Method according to claim 11, characterized in that the actuation profile (P) is selected based on the at least one object recognized in the recording and/or its type, its at least one individual property, its at least one kinematic property, its at least one image processing property, and/or its expected behavior, and/or wherein an actuation profile (P) is created by the measure module (32) based on the type of the at least one object recognized in the recording and/or its at least one individual property, its at least one kinematic property, its at least one image processing property, and/or its expected behavior.

14. Method according to claim 12, characterized in that the selection of the actuation profile (P) is adapted based on the deviation, at least one of the predetermined actuation profiles (P) is adapted based on the deviation, and/or wherein the way the actuation profile (P) is created by the measure module (32) is adapted based on the deviation.

15. Method according to claim 11, characterized in that the actuation profile (P) includes the acceleration and the velocity of the door (16), in particular the door leaf (18), at various positions during the movement; the desired travelling distance; the duration between the start of the movement and reaching various predetermined positions, optionally including the time of the start of the movement; and/or a minimal distance between one of the at least one objects to the door (16), to the door leaf (18), to the track of the door (16) and/or to the track of the door leaf (18) and/or the physical capability of the door (16).

16. Method according to claim 1, characterized in that the recording is a captured single image, a captured series of consecutive images and/or a video recording, in particular wherein the recording is captured continuously.

17. Method according to claim 1, characterized in that the measure module (32) takes additional situation data into consideration for determining the measure, the expected behavior and/or the actual behavior, in particular the additional data including current weather conditions, like ambient temperature, wind speed, air pressure, humidity, the temperature difference between opposite sides of the door (16), the air pressure difference between opposite sides of the door (16), the weekday, the time, the date, the type of the door (16), the geometry of the door (16) and/or the configuration of the door (16).

18. Method according to claim 1, characterized in that the measure module (32) and/or the adaption module (34) comprises an adaptive deterministic algorithm, a machine learning algorithm, a support vector machine and/or a trained artificial neural network.

19. Method according to claim 18, characterized in that the artificial neural network is trained using training data, wherein the training data comprises, for various training situations, input data of the same type and structure as the data which is fed to the artificial neural network during regular operation of the door system, and information about the expected correct output of the artificial neural network for the training situations; the training comprises the following training steps:
feed forward of the input data through the artificial neural network;
determining an answer output by the artificial neural network based on the input data,
determining an error between the answer output of the artificial neural network and the expected correct output of the artificial neural network; and
changing the weights of the artificial neural network by backpropagating the error through the artificial neural network, in particular wherein for the artificial neural network of the measure module (32) the input data includes recordings captured by the camera; the information about the expected correct output includes information about the actual objects in the recording including their types as well as their individual, kinematic and/or image processing properties, the measure, the expected behavior, the actual behavior and/or the deviation; and the answer output includes the actual objects in the recording, their types, their properties and/or their individual, kinematic and/or image processing properties, the measure, the expected behavior, the actual behavior and/or the deviation determined based on the input data, in particular wherein for the artificial neural network of the adaption module (34) the input data includes recordings captured by the camera; the information about the expected correct output includes the expected behavior, the actual behavior, the deviation and/or the adaption of the measure module; and the answer output includes the expected behavior, the actual behavior, the deviation and/or the adaption of the measure module.

20. System comprising an analysis unit (12) with a measure module (32) and an adaption module (34), and an automatic door system (14) having at least one door (16), at least one drive unit (22) for actuating the at least one door (16), in particular at least one door leaf (18) of the door (16), a camera (24) and a control unit (20) for controlling the drive unit (22), wherein the system (10) is configured to carry out a method according to claim 1, in particular wherein the measure module (32) is part of the door system (14), for example part of the control unit (20) and/or an integrated controller (30) the camera (24).

21. System according to claim 20, characterized in that the camera (24) is a single camera, a stereo camera, a time of flight 3D camera, an event camera or a plurality of cameras; and/or wherein the door system (14) comprises at least one additional situation sensor (26) for acquiring the additional situation data, in particular a temperature sensor, a wind sensor, a humidity sensor, a pressure sensor, and/or an interface for receiving the additional situation data.
